(19) United States
(12) Patent Application Publication
(10) Pub. No.: US 2010/0156114 A1
(43) Pub. Date: Jun. 24, 2010

(54) High Efficiency Electric Power System

(76) Inventor: Stanley Huntington, Simpson, LA (US)

Correspondence Address: JAY M. SCHLOFF, 6960 Orchard Lake Road, Suite 315, West Bloomfield, MI, 48322, US

(21) Appl. No.: 12/539,180

(22) Filed: Aug. 11, 2009

Related U.S. Application Data
(60) Provisional application No. 61/101,708, filed on Oct. 1, 2008.

(51) Int. Cl. H02K 7/18; H02K 47/20; H02K 53/00

(52) U.S. Cl. 290/1 D; 310/113; 415/916

(57) ABSTRACT

An electric power system comprising an electric generator, an electric motor, and a variable ratio transmission system. The electric generator and the electric motor are operatively connected via the variable ratio transmission system. The variable ratio transmission system provides mechanical energy from the electric motor to the electric generator which provides for the generation of electric energy. The variable ratio transmission system including an electric motor sprocket hub, an electric generator sprocket hub, a chain connecting said electric motor hub with the electric generator hub, and at least one derailleur for moving the chain to different sprockets within the electric motor hub or the electric generator hub as variations in power are needed.

### CROSS-REFERENCE TO RELATED APPLICATIONS

The present disclosure claims priority under 35 United States Code, Section 119 on the U.S. Provisional Patent Application No. 61/101,708 filed on Oct. 1, 2008, the disclosure of which is incorporated by reference.

### FIELD

The present invention generally relates to power generation. More particularly, the present invention relates to a high efficiency electric generator.

### BACKGROUND

Increased global industrialization continues to create problems with respect to the supply of energy. Increased global demand has caused energy prices to increase substantially for industry and consumers alike. Increased demand, especially during peak times has also resulted in power outages across many cities and regions.

One of the main reasons for the increase in the price of energy is due to most energy being created via the use of fossil fuels which are limited in supply. As such, alternative forms of energy are becoming more and more attractive as compared to the traditional forms of energy based on fossil fuels. Various types of alternative energy include solar energy, wind energy, and geothermal energy. Alternative energy sources also include batteries, fuel cells, and hydrogen based energy. While these types of alternative energy are available and can be advantageous for many applications, such types of energy are still very expensive thus limiting consumer and industrial use.

In addition to the increased cost, traditional forms of energy are becoming less reliable based on increased usage. Brownouts and blackouts are becoming increasingly common due to increased demand during peak time in major cities and regions. The problem of power outages will continue to increase as many consumers begin to use electricity to power vehicles such as plug-in hybrid vehicles. These problems are mainly caused by an energy infrastructure that can no longer accommodate the demands of its consumer base. Due to the problems with the current energy supply infrastructure, both industry and consumers are growing increasingly interested in energy independence by utilizing personal power systems. Personal power systems such as electric generators are becoming more popular for both everyday use and back-up power applications during power outages. With the use of electric generators becoming more and more common, there is a need in the art for electric generators operating at a high efficiency to reduce cost while providing a reliable source of power independent from the current energy infrastructure.

### SUMMARY

Disclosed herein, is an electric power system comprising an electric motor, an electric generator, and a variable transmission system. The variable transmission system comprises an electric motor sprocket hub having one or more sprockets in mechanical communication with the electric motor, an electric generator sprocket hub having two or more sprockets in mechanical communication with the electric generator, a chain connecting the electric motor hub with the electric generator hub, and at least one derailleur for moving the chain to different sprockets within the electric motor hub or the electric generator hub. The chain provides for the transfer of mechanical energy from the electric motor to the electric generator thereby producing a supply of electric energy which can be supplied to one or more electrical applications. The variable transmission system may comprise a motor sprocket derailleur operable to move the chain between two or more sprockets of the motor sprocket hub and a generator sprocket derailleur operable to move the chain between two or more sprockets of the generator sprocket hub. The one or more derailleurs may controlled by one or more toggle levers thereby providing control of the amount of electricity produced by said electric power system.

The electric motor is in electrical communication with the electric generator, to allow the electric generator to power the electric motor during operation of the electric power system.

The electric motor may be powered by an external source of power during start-up of the electric power system. The external source of power may be a rechargeable battery which is recharged by the electric generator during operation of said electric power system. The rechargeable battery may be operable to provide a supply of power to one or more electrical applications.

Also disclosed herein is a method for operating a electric power system comprising the steps of producing mechanical energy via an electric motor, transferring the mechanical energy to an electric generator via a variable ratio transmission system whereby the electric generator uses the mechanical energy to produce a supply of electricity, and supplying a portion of the supply of electricity from the electric generator to the electric motor to maintain operation of said electric power system.

The variable transmission system may comprise an electric motor sprocket hub having one or more sprockets in mechanical communication with the electric motor, an electric generator sprocket hub having two or more sprockets in mechanical communication with the electric generator, a chain connecting the electric motor hub with the electric generator hub, and at least one derailleur for moving the chain to different sprockets within the electric motor hub or the electric generator hub, the chain providing for the transfer of mechanical energy from the electric motor to said electric generator thereby producing said supply of electricity.

The method may further comprise varying the amount of electricity supplied by the electric power system by moving the chain of the variable transmission system to different sprockets in the electric motor sprocket hub or the generator sprocket hub during operation of the electric power system. The method may further comprise powering the electric motor with an external source of power during start-up of said electric power system. The external source of power may be selected from a battery or an electric outlet.

### BRIEF DESCRIPTION OF THE DRAWINGS

FIG. 1, is a depiction of an electric power system in accordance with a first embodiment the present invention.

FIG. 2 is a depiction of an electric power system in accordance with a second embodiment the present invention.

### DETAILED DESCRIPTION

In accordance with the present invention, there is provided an electric power system that provides for efficient generation of electric energy via the use of a variable ratio transmission system. The electric power systems may be utilized to provide electric energy for use in a home, office, a vehicle, or a variety of other applications. The electric power system may be portable or stationary depending on the desired output and use of the system. The electric power system may be stand alone or used to supplement power received from a power grid.

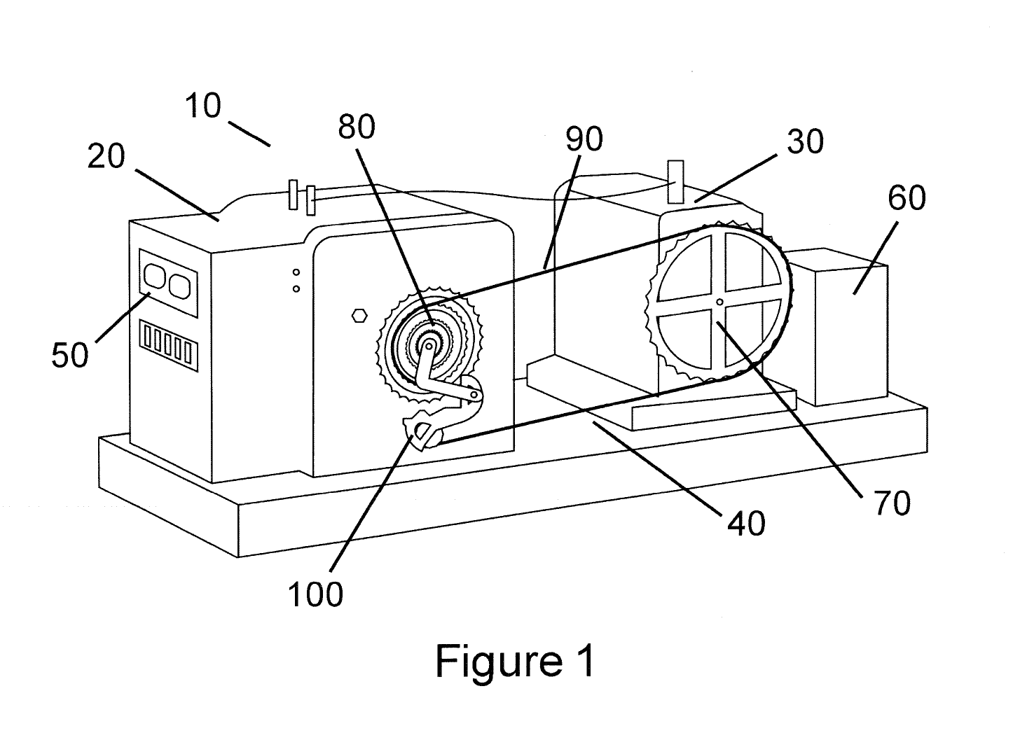

The electric power system 10 in accordance with the present invention is depicted in FIG. 1. The electric power system comprises an electric generator 20, an electric motor 30, and a variable ratio transmission system 40. The electric generator 20 and the electric motor 30 are operatively connected via the variable ratio transmission system 40. The variable ratio transmission system 40 provides mechanical energy from the electric motor 30 to the electric generator 20 which provides for the generation of electric energy.

The electric generator 20 may be any type electric generator capable of producing an electric current upon being supplied mechanical energy from the electric motor. The electric generator may provide 10,000 watt surge power and 9,500 watt continuous power with 120 volts or 240 volts of alternating current. The electric generator may comprise one or more electric outlets 50 for receiving electric connectors or plugs of a device or appliance to which the system may provide power. The one or more electric outlets 50 may be integrated into or mounted on the electric generator. The electric outlets may be 120 volt/20 amp outlets or 120/240 volt/50 amp outlets. The electric generator may also be directly wired into one or more electric applications and/or electric hubs.

The electric motor 30 of the electric power system 10 may be any type motor powered by electric energy which produces mechanical energy that is transferable to the electric generator 20. The electric motor may be a one horsepower motor with operation at high torque with low amps to maintain the necessary rpm ratio. To provide the necessary mechanical energy to provide the required power output, the shaft of the electric motor may rotate at a speed in the range of 1000 to 2000 rpm. Various sizes of electric motors with varying horsepower may be used in accordance with the present invention. As such, the rotational speed of the electric motor may also vary as needed to provide the necessary rotational energy to the electric generator to provide for the desired power output. The electric motor accordingly provides sufficient mechanical energy to operate the electric generator.

The variable ratio transmission system 40 is mechanically coupled to the electric motor such that mechanical energy produced by the electric motor 30 is transferred to the electric generator 20 to produce an electric current. During operation of the electric power system 10, the electric motor 30 is powered by the electric generator 20. The electric motor 30 may be directly wired to the electric generator 20 or may be plugged into an outlet 50 of the electric generator via an electric cord and plug. During start-up of the electric power system 10, the electric motor 30 is initially powered by an external source of electric power 60 separate from the electric generator 20. A transfer switch may be used to electrically connect the electric motor 30 to the external source of electric power 60 during start-up. Once the electric power system 10 is started and electric current is being generated by the electric generator 20, the transfer switch is actuated to disconnect the electric motor 30 from the external source of power 60 and the electric motor 30 is then powered by the electric generator 20. The external source of electric power 60 may be a battery an electric outlet. The battery may be a 12-volt battery with a 600-watt inverter. The battery may also be a rechargeable battery in electric communication with the electric generator such that the rechargeable battery is recharged during operation of the electric power system. The rechargeable battery may also include one or more electric outlets such that electric energy can be supplied from the rechargeable battery if needed.

The variable ratio transmission system 40 comprises a motor sprocket hub 70 and a generator sprocket hub 80 which are mechanically connected via a chain 90. The motor sprocket hub 70 may include one or more coaxially connected sprockets arranged by size smaller to greatest. The motor sprocket hub 70 may be attached to a spindle on the electric motor which provides for transfer of mechanical energy from the electric motor 30 to the variable ratio transmission system 40. The generator sprocket hub 80 may include two or more coaxially connected sprockets arranged by size smaller to greatest. The generator sprocket hub 80 may be attached to a spindle of the electric generator 20 therefore allowing mechanical energy to be transferred to the electric generator 20 from the electric motor 30 via the variable ratio transmission system 40 providing for power generation. A chain 90 fits around the motor sprocket hub 70 and the generator sprocket hub 80 which provides for the transfer of mechanical energy from the electric motor 30 to the electric generator 20.

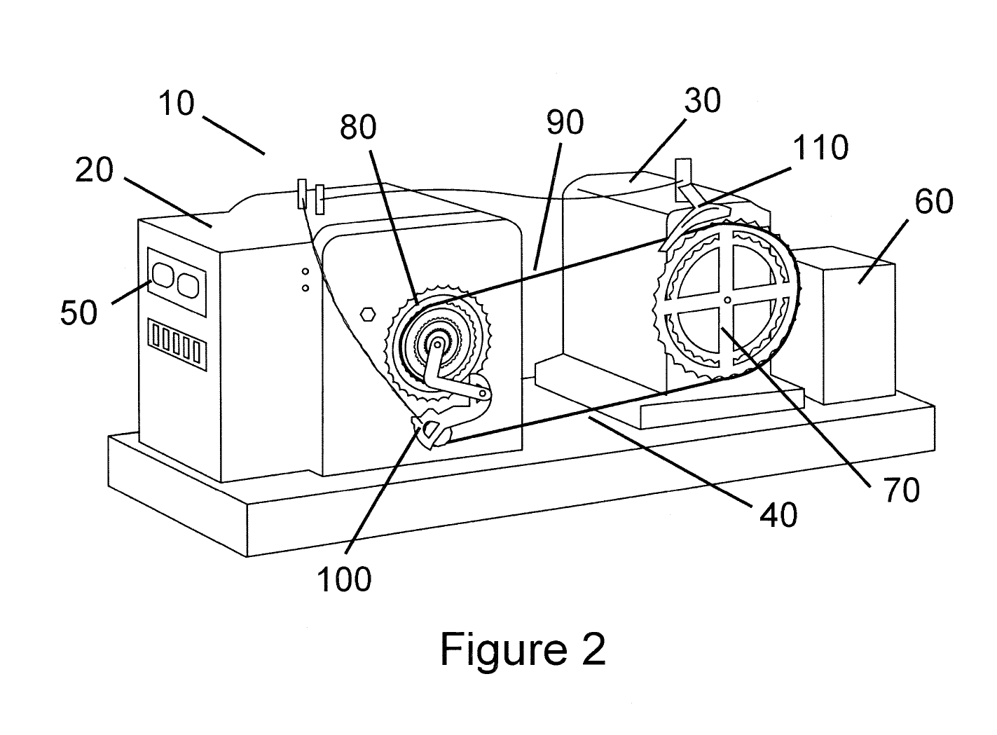

The variable ratio transmission system 40 may further comprise at least one derailleur, which moves the chain to the different sprockets of the variable ratio transmission system as variations in power are needed. The generator sprocket hub 80 includes a generator sprocket derailleur 100 which moves the chain to the different sprockets in the generator sprocket hub 80 during operation of the electric power system 10. As the electric generator 20 demands additional power from the electric motor 30 to supply an increased amount of electric current, the generator sprocket derailleur 100 changes the chain to a smaller sprocket in the generator sprocket hub 80. Should a decrease in the need for power from the electric motor 30 occur, the generator sprocket derailleur 100 may move the chain 90 to a larger sprocket in the generator sprocket hub 80 to make the necessary accommodation. The motor sprocket hub may include a motor sprocket derailleur 100 which moves the chain to the different sprockets in the motor sprocket hub 70 during operation of the electric power system as shown in FIG. 2. When the motor sprocket hub comprises only one sprocket the motor sprocket derailleur is not required as shown in FIG. 1. The one or more derailleurs generally comprise a moveable chain-guide that is operated remotely by one or more toggle levers which enable the chain to be set to the desired sprocket thereby producing a desired electric output. The chain-guide may be actuated by one or more toggle levers. The toggle levers may move the chain-guide via a cable. Alternatively, the toggle levers may cause the chain-guide to move remotely via a mechanical device which causes the chain-guide to move in a desired direction. The toggle levers may be operated either automatically or manually.

The electric power system may additionally include one or more visual performance indicators. The visual performance indicators may be selected from gauges, visual displays, or meters which provide operating characteristics of the electric power system. Information that may be displayed by the visual performance indicators may include power output of the system, voltage draw, rpm of the electric motor, and state of charge of the battery pack.

To begin operation of the electric power system, electric energy is provided to the electric motor from a source of electric power such as a battery or an electric outlet. The electric motor then begins operations and causes the motor sprocket hub to rotate thereby transferring mechanical energy to the variable ratio transmission system. The variable ratio transmission then transfers the mechanical energy to the generator sprocket hub which causes the spindle of the electric generator to rotate thereby producing electric energy. A portion of the electric energy generated by the electric generator is then supplied back to the electric motor which enables the electric motor to continue operation. The remaining portion of the electric energy generated by the electric generator is then available for use by one or more electric applications.

During operation of the electric power system, the variable ratio transmission system may use one or more derailleurs to vary the electric output of the system. The generator sprocket derailleur may move the chain to various sprockets in the generator sprocket hub based on the desired power output of the electric generator. For instance, if increased power output is desired the chain may be moved to a smaller sprocket within the generator sprocket hub. Similarly, if decreased power output is desired the chain may be moved to a larger sprocket within the generator sprocket hub. As previously described, the motor sprocket hub may include multiple sprockets. In such case, a motor sprocket derailleur will be used in conjunction with the motor sprocket hub. To increase the mechanical energy supplied from the electric motor to the electric generator, the chain may be moved to a larger sprocket within the motor sprocket hub thereby increasing the rotational energy supplied to the electric generator. Similarly, to decrease the mechanical energy supplied from the electric motor to the electric generator, the chain may be moved to a smaller sprocket within the motor sprocket hub thereby decreasing the rotational energy supplied to the electric generator.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

1. An electric power system comprising:
an electric motor;
an electric generator; and
a variable transmission system, said variable transmission system comprising an electric motor sprocket hub having one or more sprockets in mechanical communication with said electric motor, an electric generator sprocket hub having two or more sprockets in mechanical communication with said electric generator, a chain connecting said electric motor hub with said electric generator hub, and at least one derailleur for moving the chain to different sprockets within said electric motor hub or said electric generator hub, said chain providing for the transfer of mechanical energy from said electric motor to said electric generator thereby producing a supply of electricity.

2. The electric power system according to claim 1, wherein said variable transmission systems comprises a motor sprocket derailleur operable to move the chain between two or more sprockets of said motor sprocket hub and a generator sprocket derailleur operable to move the chain between two or more sprockets of said generator sprocket hub.

3. The electric power system according to claim 1, wherein said derailleur is controlled by one or more toggle levers providing for variation in the amount of electricity supplied by said electric power system.

4. The electric power system according to claim 1, wherein said electric motor is in electrical communication with said electric generator, said electric generator powering said electric motor during operation of said electric power system.

5. The electric power system according to claim 1, wherein said electric motor is powered from an external source of power during start-up of said electric power system.

6. The electric power system according to claim 5, wherein said external source of power is a rechargeable battery.

7. The electric power system according to claim 1, wherein said rechargeable battery is recharged by said electric generator during operation of said electric power system.

8. The electric power system according to claim 1, wherein said rechargeable battery is operable to provide a supply of power to one or more electrical applications.

9. A method for operating an electric power system comprising the steps of:
producing mechanical energy via an electric motor;
transferring said mechanical energy to an electric generator via a variable ratio transmission system, said mechanical energy being used by said electric generator to produce a supply of electricity;
supplying a portion of said supply of electricity from said electric generator to said electric motor to maintain operation of said electric power system.

10. The method according to claim 9, wherein said variable transmission system comprises an electric motor sprocket hub having one or more sprockets in mechanical communication with said electric motor, an electric generator sprocket hub having two or more sprockets in mechanical communication with said electric generator, a chain connecting said electric motor hub with said electric generator hub, and at least one derailleur for moving the chain to different sprockets within said electric motor hub or said electric generator hub, said chain providing for the transfer of mechanical energy from said electric motor to said electric generator thereby producing said supply of electricity.

11. The method according to claim 10 further comprising:
varying the amount of electricity supplied by said electric power system by moving the chain of said variable transmission system to different sprockets in said electric motor sprocket hub or said generator sprocket hub during operation of said electric power system.

12. The method according to claim 9 further comprising:
powering said electric motor with an external source of power during start-up of said electric power system.

13. The method according to claim 12, wherein said external source of power is selected from a battery or an electric outlet.
